(19) United States
(12) Patent Application Publication
(10) Pub. No.: US 2003/0047849 A1
(43) Pub. Date: Mar. 13, 2003

(54) Method of modifying the temperature stability of a low temperature cofired ceramics (LTCC)

(75) Inventors: Xunhu Dai, Gilbert, AZ (US); Rong Fong Huang, Fremont, CA (US)

Correspondence Address: MOTOROLA, INC., CORPORATE LAW DEPARTMENT - #56-238, 3102 NORTH 56TH STREET, PHOENIX, AZ, 85018, US

(73) Assignee: Motorola, Inc.

(21) Appl. No.: 09/952,784

(22) Filed: Sep. 11, 2001

(51) Int. Cl. C04B 33/32

(52) U.S. Cl. 264/681; 264/614

(57) ABSTRACT

A method to fabricate a printed circuit board with a low temperature coefficient of resonant frequency comprising the steps of mixing a volume of glass particles, a volume of filler material, and a volume of finely modifier powder. The function of the finely modifier powder is to adjust the low temperature of resonant frequency. The mixture is sintered at a temperature to form a low temperature cofired ceramic which will have a low temperature coefficient of resonant frequency that is approximately zero.

### FIELD OF THE INVENTION

This invention relates to ceramics.

More particularly, the present invention relates to low temperature cofired ceramics used in multilayer ceramic integrated circuit boards.

### BACKGROUND OF THE INVENTION

Printed circuit boards for use in high frequency semiconductor device circuitry are a critical component in electronic systems such as wireless and mobile telephones. One type of printed circuit board uses a resin substrate onto which the conductor patterns are held. However, there are many problems with using resin substrates. First, it is extremely difficult to form multi-layer conductor circuit patterns.

Resin circuit boards also have a relatively low dielectric constant. Finally, resin circuit boards have a high temperature coefficient of resonant frequency, which makes the device circuitry unstable with temperature. These problems affect the reliability of the electronic components used on the printed circuit board.

An alternative is to use low temperature cofired ceramic (hereinafter referred to as “LTCC”) dielectric printed circuit boards. LTCC dielectrics offer several advantages. First, they can be processed at low temperature (less than 950° C.) with low resistivity and low melting point metals, such as copper or silver. The metals function as wires to interconnect the various electronic components within the circuitry, so it is critical to minimize the transmission losses. Ideally, a low resistivity metal should be used so that the Q value (it is desirable to have Q values greater than 500) of the circuit is increased and the performance is improved. Since most metals with ideal electrical properties have low melting points, it is necessary to fabricate the printed circuit board with materials that can be processed at low temperature.

Another advantage is that LTCC dielectrics can be formed into multi-layer structures. This feature allows the metal interconnects to be distributed both on and within the layered LTCC dielectric. Metal interconnects positioned within the layered structure minimizes the required area necessary to hold an electronic circuit since now the metal interconnects can be routed in three dimensions.

However, a problem with LTCC dielectrics is the temperature coefficient of resonant frequency (hereinafter referred to as “T_{f}”). T_{f} refers to the change in the resonant frequency of the circuit as a function of temperature. Although T_{f} of LTCC dielectrics is superior to that of resin substrates, the performance of the high frequency circuitry can be improved if T_{f} is near zero. For most high frequency applications, a T_{f} of less than ±10 parts per million per ° C. (hereinafter referred to as “ppm/° C.”) is adequate. LTCC dielectrics typically have a T_{f} in the range of −40 ppm/° C. to −150 ppm/° C.

T_{f} of a given LTCC dielectric is primarily determined by the temperature coefficient of dielectric constant (hereinafter referred to as “T_{ε}”). A method to adjust T_{f} to a value closer to zero is to add a modifier material, such as TiO₂, that has an opposite T_{ε}. Typically, TiO₂ particles are added to the starting LTCC dielectric before it is cofired. A relatively high weight percentage (15 wt % to 20 wt %) of TiO₂ is usually needed to adjust T_{f} to within ±5 ppm/° C. according to the role of mixing phases. Unfortunately, introducing a large weight percent of TiO₂ changes the chemistry and the high frequency properties of the LTCC dielectric.

It would be highly advantageous, therefore, to remedy the foregoing and other deficiencies inherent in the prior art.

Accordingly, it is an object of the present invention to provide a new and improved low temperature cofired ceramic.

It is an object of the present invention to provide a new and improved low temperature cofired ceramic which has a low temperature coefficient of resonant frequency with significantly less amount of modifier material.

It is another object of the present invention to provide a new and improved low temperature cofired ceramic which can incorporate metals that have a low resistivity.

It is another object of the present invention to provide a new and improved low temperature cofired ceramic which has a large Q value.

A further object of the invention is to provide a new and improved low temperature cofired ceramic which can be fabricated in multiple layers.

### SUMMARY OF THE INVENTION

To achieve the objects and advantages specified above and others, a method of fabricating a LTCC dielectric with a low temperature coefficient of resonant frequency is disclosed. The method of fabrication includes providing a volume of glass particles, a volume of filler material, and a volume of fine sized modifier material.

The volume of glass particles, filler material, and modifier material are mixed together such that they form an approximately homogenous mixture. The homogenous mixture is then sintered at a temperature where the mixture will undergo a self-limiting reaction wherein the part of the filler material reacts with glass to form a high Q crystalline phase and the homogenous mixture undergoes a chemical reaction to form a low temperature cofired ceramic. At the same time part of the fine modifier powder is also dissolved into glass and reacts with specific chemical species in the glass to form a crystalline titanium compound. After sintering, the low temperature cofired ceramic will generally include a low Q residual glass phase left from the initial glass particles, high Q crystalline phases which are the products from reaction of glass and filer material, and un-reacted filler material. In addition, a phase of crystalline titanium compounds are formed from the reaction between fine modifier powder and glass. Also included in the low temperature cofired ceramic are isolated regions of un-reacted modifier particles. It is believed that the dissolution/reaction of modifier material with glass and the subsequent formation of crystalline titanium compounds, which is unique to the present invention, contribute significantly to the modification of the temperature coefficient of the LTCC dielectric. This is the reason that significantly less amount of modifier material can be used to effectively adjust the T_{f} to near 0 ppm/° C.

The function of the modifier material is to adjust the low temperature coefficient of resonant frequency to a value close to zero. However, it is desired to minimize the wt % of modifier material introduced into the modifier mixture. By using a minimum wt % of modifier material, the chemistry of the low temperature cofired ceramic is not affected significantly.

In prior art, the low temperature coefficient of resonant frequency can be achieved by using only isolated modifier particles. The fabrication process in the present invention is improved because part of the fine modifier material is dissolved during the sintering process to form crystalline titanium compounds. By forming crystalline titanium compounds from the fine modifier material, the temperature coefficient of resonant frequency can be adjusted much more efficiently. Thus, the wt % of the modifier material in the low temperature cofired ceramic can be reduced. The advantage of this method is that the low temperature coefficient of resonant frequency can be adjusted to a range of approximately −5 ppm/° C. to +5 ppm/° C. while introducing less than 10 wt % of modifier material.

### DETAILED DESCRIPTION OF THE PREFERRED EMBODIMENT

According to the present invention, a low temperature cofired ceramic is formed of a composition of materials which gives a low temperature coefficient of resonant frequency in the range of approximately −5 ppm/° C. to +5 ppm/° C. while introducing less than 10 wt % of a modifier material. The method for fabricating the low temperature cofired ceramic involves the following steps. First, a volume of glass particles, a volume of filler material, and the volume of modifier material are mixed together to form an approximately homogenous mixture. In the preferred embodiment, the homogenous mixture is approximately 30 wt % to 70 wt % glass particles, 30 wt % to 70 wt % filler material, and less than 10 wt % modifier material.

It will be understood that the volume of glass particles can include materials such as SiO₂, at least one of B₂O₃, MgO, CaO, SrO, and BaO, and at least one of K₂O, Na₂O, and Li₂O. Further, the filler material generally includes a high Q material, such as Al₂O₃. In the preferred embodiment, the modifier material includes TiO₂, but it will be understood that other compounds, such as SrTiO₃, and CaTiO₃ could also be used.

The critical property of the modifier material is that it has a positive temperature coefficient of resonant frequency so that the generally negative temperature coefficient of resonant frequency of the temperature cofired ceramic will be made more positive and adjusted to a value closer to zero. It will be understood that if the temperature coefficient of resonant frequency is positive, than a modifier material with a negative temperature coefficient of resonant frequency would be appropriate.

The method includes in the modifier material a volume of finely ground modifier powder. The importance of the finely ground modifier powder is to promote reaction between the modifier powder and form the desired titanium coupounds. The desired result is to adjust the low temperature coefficient of resonant frequency to a value of approximately zero by introducing the minimum wt % of modifier material.

In the preferred embodiment, the finely ground modifier powder has a BET specific surface area >5 m²/g and a particle size <1.0 μm. The size and area of the finely ground modifier powder is selected to minimize the wt % of the modifier material introduced. It is desired to have the wt % of the modifier material less than 10 wt %.

The homogenous mixture is sintered at a temperature where the mixture will undergo a self-limiting reaction wherein the finely ground modifier powder is consumed to form titanium compounds, and the homogenous mixture undergoes a chemical reaction to form a low temperature cofired ceramic. In the preferred embodiment, the sintering temperature is in the range of approximately 800° C. to 950° C. After sintering, the low temperature cofired ceramic will include a low Q glass phase, a high Q Al₂O₃ phase, high Q crystalline phases from the reaction of Al₂O₃ and glass, a phase of crystalline titanium compounds, and isolated regions of modifier particles. Also, the sintered low temperature cofired ceramic has a dielectric constant in the range between approximately 6 to 15.

To further clarify the concept of the present fabrication method, the following specific example will be described. The example involves mixing together the volume of glass particles, the volume of filler material, and the volume of modifier material to form an approximately homogenous mixture. In this specific example, the filler material is Al₂O₃ and the modifier material is TiO₂. The unfired homogenous mixture is approximately 44.7 wt % ceramic particles, 49.1 wt % filler material, and 6.2 wt % modifier material, as shown in the following table.

| | | | Wt % | | |
|---|---|---|---|---|---|
| | | Wt % high Q | Titanium | | |
| | Wt % | Crystalline | compound | Wt % | Wt % |
| | Glass | phases | phase | Al₂O₃ | TiO₂ |
| Unfired | 44.7 | N/A | N/A | 49.1 | 6.2 |
| Homogenous | | | | | |
| Mixture | | | | | |
| Cofired | 12 | 41.5˜43.5 | 3˜5 | ˜40 | ˜3.5 |
| Ceramic | | | | | |

During the sintering process, the homogenous mixture undergoes a chemical reaction to form a low temperature cofired ceramic. In this example, the sintering temperature is approximately 875° C. After sintering, the low temperature cofired ceramic will include a low Q glass phase left from the glass particles, high Q crystalline phases from the reaction of glass and Al₂O₃, a phase of crystalline titanates formed from the finely ground TiO₂ powder, and a high Q Al₂O₃ phase from the filler material. Also included in the low temperature cofired ceramic are isolated regions of un-reacted modifier particles, which in this example includes TiO₂. After sintering, the low temperature cofired ceramic composition is approximately 12 wt % of a glass phase, 41.5˜43.5 wt % of high Q crystalline phases MSi₂Al₂O₈ (M=Ca, Ba or Sr), 40 wt % of a high Q Al₂O₃ phase, 3˜5 wt % of titanium crystalline compounds, and 3.5 wt % of unreacted TiO₂ particle and titanium compound phase, as shown in the table.

The important result of this example is that the low temperature coefficient of resonant frequency has been adjusted to within a range of approximately −5 ppm/° C. to +5 ppm/° C. while introducing less than 10 wt % of modifier material. This result is achieved by using finely ground modifier material. The finely ground modifier material reacts with glass and forms crystalline titanium compounds during the sintering process. The crystalline titanium compounds along with the modifier particles adjust the low temperature coefficient of resonant frequency much more efficiently than by using only modifier particles. The advantage of this method is that by using a minimum wt % of modifier material, the chemistry of the low temperature cofired ceramic is not affected significantly.

Various changes and modifications to the embodiments herein chosen for purposes of illustration will readily occur to those skilled in the art. To the extent that such modifications and variations do not depart from the spirit of the invention, they are intended to be included within the scope thereof which is assessed only by a fair interpretation of the following claims.

Having fully described the invention in such clear and concise terms as to enable those skilled in the art to understand and practice the same, the invention claimed is:

1. A method of fabricating a low temperature cofired ceramic dielectric material with a low temperature coefficient of resonant frequency comprising the steps of:
providing a volume of glass particles;
providing a volume of finely ground modifier powder whose function is to adjust the temperature of resonant frequency;
providing a volume of ceramic filler material whose function is to form high Q crystalline phases;
mixing the volume of ceramic particles, finely ground modifier powder, and filler material such that they form an approximately homogenous mixture; and
sintering the homogenous mixture at a temperature such that the mixture undergoes a self-limiting reaction wherein the finely ground modifier powder is partially consumed and the homogenous mixture undergoes a chemical reaction to form a low temperature cofired ceramic that includes a glass phase, a phase of crystalline titanates, un-reacted TiO₂, high Q crystalline phases from reaction between filler Al₂O₃ and glass, and a high Q Al₂O₃ phase.

2. A method of fabricating a low temperature cofired ceramic dielectric material with a low temperature coefficient of resonant frequency as claimed in claim 1 wherein the low temperature cofired ceramic formed from sintering the mixture has a dielectric constant in the range between approximately 6 to 15.

3. A method of fabricating a low temperature cofired ceramic dielectric material with a low temperature coefficient of resonant frequency as claimed in claim 1 wherein the low temperature cofired ceramic has a Q value of at least 500.

4. A method of fabricating a low temperature cofired ceramic dielectric material with a low temperature coefficient of resonant frequency as claimed in claim 1 wherein the temperature coefficient of resonant frequency of the cofired ceramic is in the range of approximately −5 ppm/° C. to +5 ppm/° C.

5. A method of fabricating a low temperature cofired ceramic dielectric material with a low temperature coefficient of resonant frequency as claimed in claim 1 further including the step using a finely ground modifier powder that has a BET specific surface area >5 m²/g and a particle size <1.0 μm.

6. A method of fabricating a low temperature cofired ceramic dielectric material with a low temperature coefficient of resonant frequency as claimed in claim 5 wherein the wt % of the finely ground modifier powder is less than 10%.

7. A method of fabricating a low temperature cofired ceramic dielectric material with a low temperature coefficient of resonant frequency as claimed in claim 6 wherein the finely ground modifier powder includes one of TiO₂, SrTiO₃, and CaTiO₃.

8. A method of fabricating a low temperature cofired ceramic dielectric material with a low temperature coefficient of resonant frequency comprising the steps of:
providing a volume of a ceramic material composed of approximately 30 wt % to 70 wt % of a glassy precursor material, approximately 30 wt % to 70 wt % of an Al₂O₃ filler material, and less than 10 wt % of a TiO₂ modifier material;
mixing the glassy precursor material, Al₂O₃ filler material, and TiO₂ modifier material such that they form an approximately homogenous mixture; and
sintering the homogenous mixture at a temperature in approximately the range between 800° C. and 950° C. wherein the mixture undergoes a self-limiting reaction and forms a low temperature cofired ceramic.

9. A method of fabricating a low temperature cofired ceramic dielectric material with a low temperature coefficient of resonant frequency as claimed in claim 8 wherein the low temperature cofired ceramic is characterized by a dielectric constant in the range between approximately 6 to 15.

10. A method of fabricating a low temperature cofired ceramic dielectric material with a low temperature coefficient of resonant frequency as claimed in claim 8 wherein the low temperature cofired ceramic has a Q value of at least 500.

11. A method of fabricating a low temperature cofired ceramic dielectric material with a low temperature coefficient of resonant frequency as claimed in claim 8 wherein the low temperature coefficient of resonant frequency of the low temperature cofired ceramic is in the range of approximately −5 ppm/° C. to +5 ppm/° C.

12. A method of fabricating a low temperature cofired ceramic dielectric material with a low temperature coefficient of resonant frequency as claimed in claim 8 wherein the finely ground TiO₂ powder has a BET specific surface area >5 m²/g and a particle size <1.0 μm.

13. A method of fabricating a low temperature cofired ceramic dielectric material with a low temperature coefficient of resonant frequency as claimed in claim 8 wherein the TiO₂ particles have a reduced BET specific surface area greater than 5 m²/g.

14. A method of fabricating a low temperature cofired ceramic dielectric material with a low temperature coefficient of resonant frequency comprising the steps of:
providing a volume of glass particles;
providing a volume of finely ground TiO₂ powder;
providing a volume of ceramic filler material;
mixing the volume of glass particles, finely ground TiO₂ powder, and ceramic filler material such that they form an approximately homogenous mixture; and
sintering the homogenous mixture at a temperature such that the mixture undergoes a self-limiting reaction wherein the finely ground TiO₂ powder are partially consumed and the homogenous mixture forms a low temperature cofired ceramic that includes a glass phase, a phase of crystalline titanates, un-reacted TiO₂, high Q crystalline phases from reaction between filler Al₂O₃ and glass, and a high Q Al₂O₃ phase.

15. A method of fabricating a low temperature cofired ceramic dielectric material with a low temperature coefficient of resonant frequency as claimed in claim 14 wherein the low temperature cofired ceramic is characterized by a dielectric constant in the range between approximately 6 to 15.

16. A method of fabricating a low temperature cofired ceramic dielectric material with a low temperature coefficient of resonant frequency as claimed in claim 14 wherein the low temperature cofired ceramic has a Q value of at least 500.

17. A method of fabricating a low temperature cofired ceramic dielectric material with a low temperature coefficient of resonant frequency as claimed in claim 14 wherein the coefficient of resonant frequency of the low temperature cofired ceramic is in the range of approximately −5 ppm/° C. to +5 ppm/° C.

18. A method of fabricating a low temperature cofired ceramic dielectric material with a low temperature coefficient of resonant frequency as claimed in claim 14 further including the step using TiO₂ powder that has a BET specific surface area >5 m²/g and a particle size <1.0 μm.

19. A method of fabricating a low temperature cofired ceramic dielectric material with a low temperature coefficient of resonant frequency as claimed in claim 14 wherein the wt % of the finely ground TiO₂ powder is less than 10%.
